(19) United States
(12) Patent Application Publication
(10) Pub. No.: US 2008/0144443 A1
(43) Pub. Date: Jun. 19, 2008

(54) Global Timepiece for the Contemporary Indication of Local Times and Data Around the Globe

(76) Inventor: Keith Herbert, Boynton Beach, FL (US)

Correspondence Address: EDWIN D. SCHINDLER, FIVE HIRSCH AVENUE, P.O. BOX 966, CORAM, NY, 11727-0966, US

(21) Appl. No.: 11/815,553

(22) PCT Filed: Jan. 24, 2006
(86) PCT No.: PCT/IB06/00171

§ 371 Date: Oct. 1, 2007

Related U.S. Application Data
(63) Continuation of application No. 11/184,942, filed on Jul. 19, 2005, now abandoned.
(60) Provisional application No. 60/649,864, filed on Feb. 3, 2005.
(60) Provisional application No. 60/649,864, filed on Feb. 3, 2005.

(51) Int. Cl. G04B 19/22; G04B 19/24

(52) U.S. Cl. 368/21; 368/28

(57) ABSTRACT

A global timepiece includes a transparent disk, which is arranged overhead the face of the timepiece, which has a New Day Line extending radially from the center outwardly to an indice indicating midnight. The transparent disk is operationally connected to a rotatable shaft, or other drive mechanism, by which it is moving the transparent disk 360° in a clockwise direction within 24 hours. The disk further includes an International Date Line indicia and time zone indicia represented by cities, or areas, or marks, representing a time zone geographically located within each corresponding time zone. Two windows for the indication of two successive dates are cut into the face. These windows are aligned astride in the New Day Line. A wheel is arranged beneath these windows and moves counterclockwise and indicates, on its circumferential top area, the relevant dates. By this wheel, the timepiece shows two successive dates in the windows and which world locations are in which date.

The present invention generally relates to watches, clocks and other timepieces, and, more particularly, to a watch that indicates global times and dates.

Existing solutions of such timepieces have either rotatable outer rings (e.g., Patek Phillippe style watches) or a small central rotatable faceplate (e.g., Walden style watch) both covering a portion of the dial or bezel with geographical time zone indicia using city or other name indicia. Although fully functional, the design of these timepieces limits the amount of information that can be displayed. More particularly, the dial of the presently available timepieces, e.g., analog type watches is mostly filled or obscured with time zone rings or plates, and thus there is little or no room to provide additional relevant information, e.g., displays such as chronograph (stop watch), power reserve indicator, moon phase indicator, alarm indicator, etc. Further, in the second instance, the present 24 hour world time watches do not display both days and both dates that exist simultaneously across the world and do not display which time zones are in which day and which date and do not display how the day and the date change for each time zone from hour-to-hour and do not do so in a manner to allow space on the traditional size watch face or dial for display of various other traditional information such as, but not limited to, chronograph, power reserve indicator, alarm, moon phase, and so forth.

It is therefore the objective of the present invention to provide a global timepiece that does not have the limitations of the presently available timepieces; but that provides for displaying the local time in all of the world's 24 time zones at a glance. In special executions, the timepiece should as well display the dates in all of the world's 24 time zones and in a yet other embodiment in addition the week days in all of the world's time zones, and at a glance, whether it is daylight or night time in those zones. In yet other executions the timepiece should indicate the power reserve, have an alarm function, or show the moon phase or any other complications known to the art.

This objective is achieved with a global timepiece with a case, a movement mechanism having at least one rotatable shaft or other drive mechanism housed in the case, a face positioned over the movement mechanism, with the at least one rotatable shaft or other drive mechanism extending through that face and at least an hour hand and a minute hand, whereby this timepiece is characterized in that a transparent disk is arranged overhead the face which face comprises a New Day Line extending radially from the center outward to an indice indicating midnight, and the disk being operationally connected to the at least one rotatable shaft or other drive mechanism by which said disk is rotating 360° in clockwise direction within 24 hours, the disk comprising an International Date Line indicia, time zone indicia represented by cities or areas or marks representing cities and areas geographically located within each corresponding time zone so that the local times around the world are indicated contemporarily.

A number of non-limiting executions of this timepiece are shown in the accompanying drawings as mere examples. These examples will be described and explained in the description and advantages of these timepieces will be clarified taken together with the attached drawings, in which like reference numerals represent like elements throughout.

Shown is in:

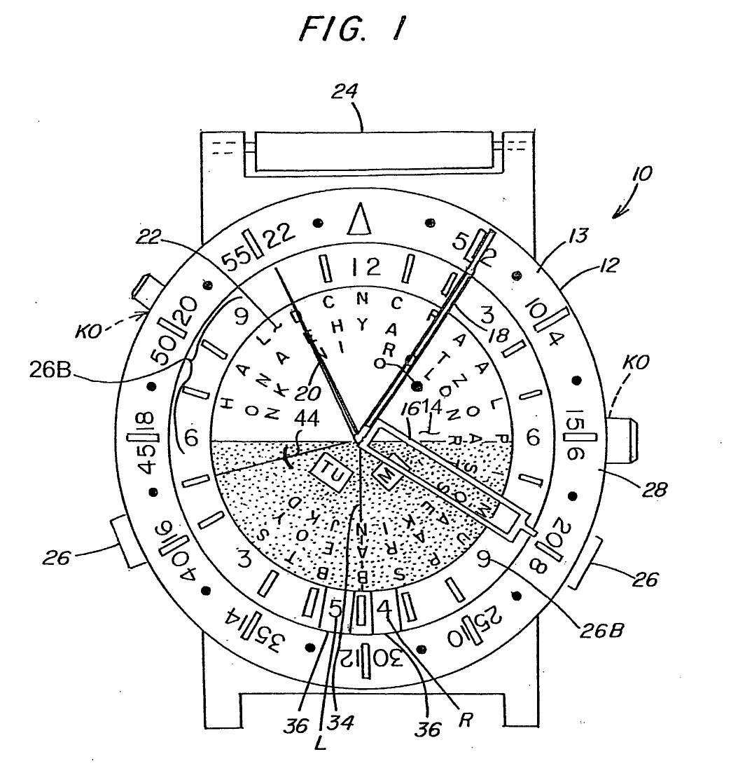

FIG. 1 a top plan view of a global timepiece of the present invention, which includes a transparent disk, an hour, a minute and a second hand, a bezel and a face with dual day and dual date window;

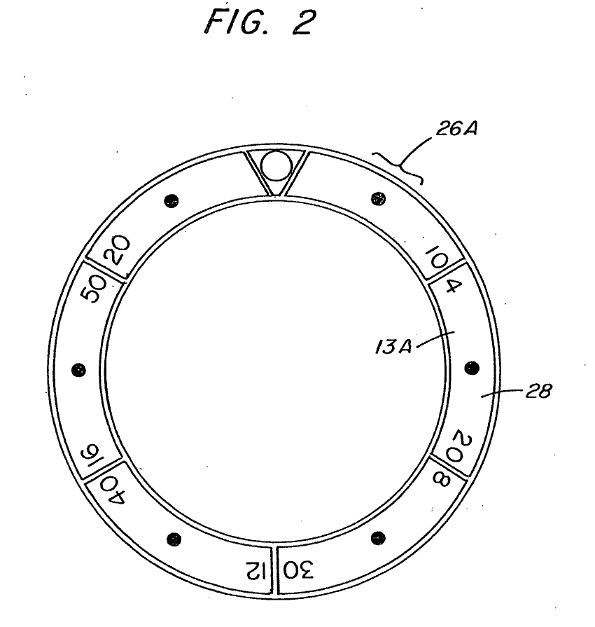

FIG. 2 a top plan view of another embodiment of a bezel incorporating features of the invention;

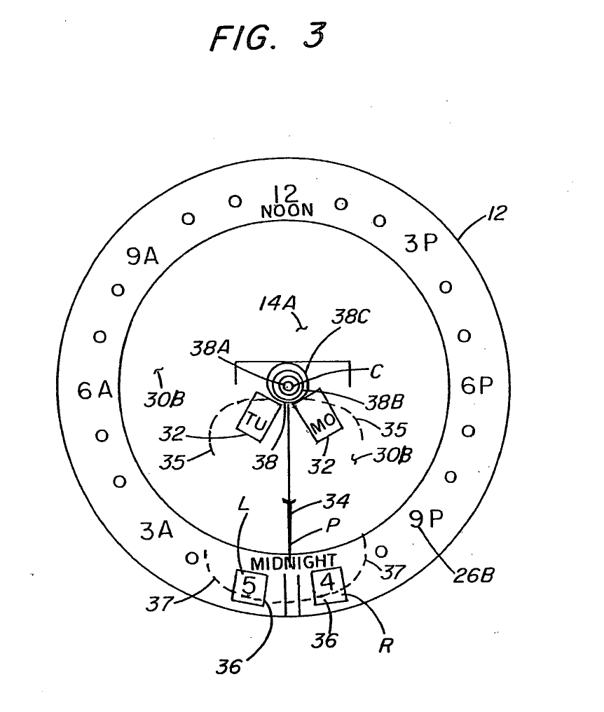

FIG. 3 a top plan view of another embodiment of a face incorporating features of the invention;

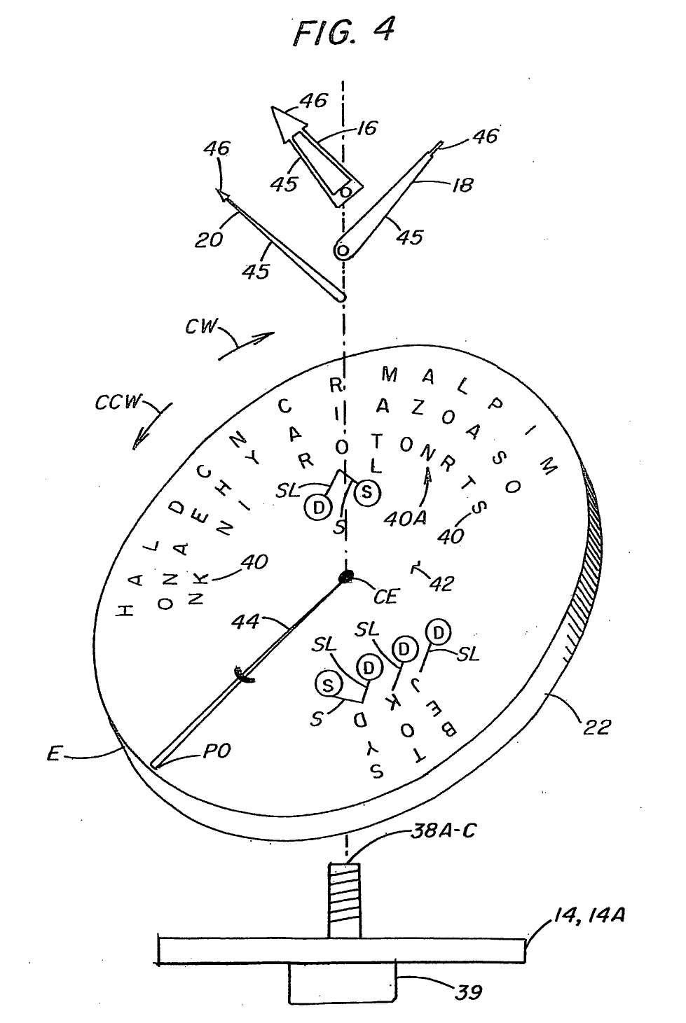

FIG. 4 a breakaway view of a timepiece showing a perspective view of an embodiment of a transparent disk;

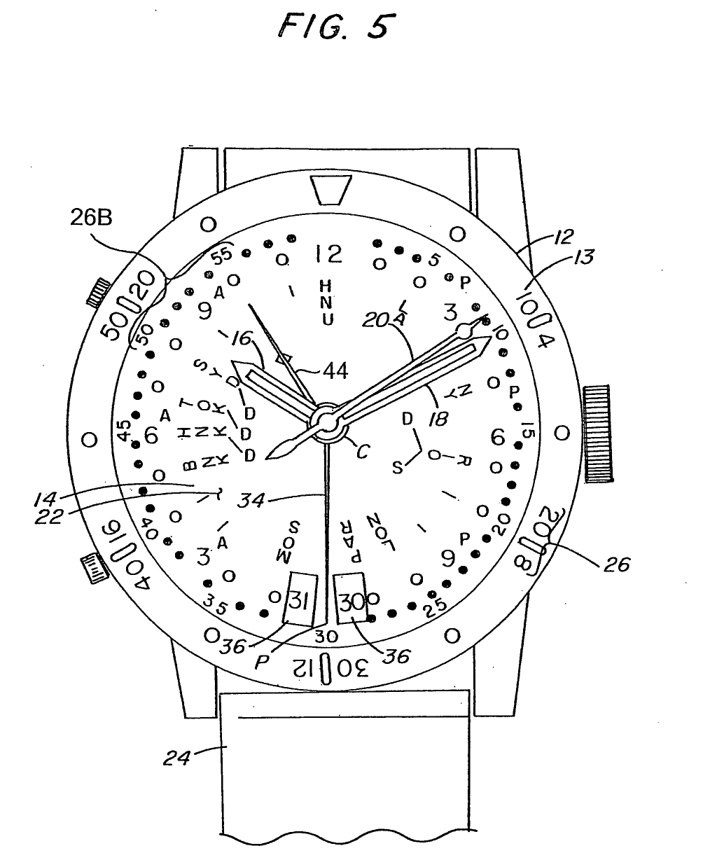

FIG. 5 a wristwatch for the contemporary indication of local world times and dates worldwide;

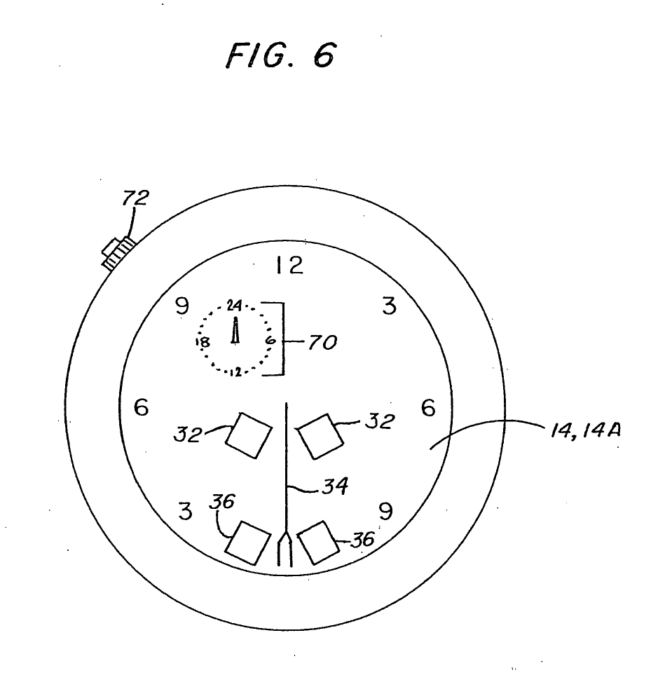

FIG. 6 a top plan view of a further timepiece with a 24 hour alarm set by a pin protruding from the case;

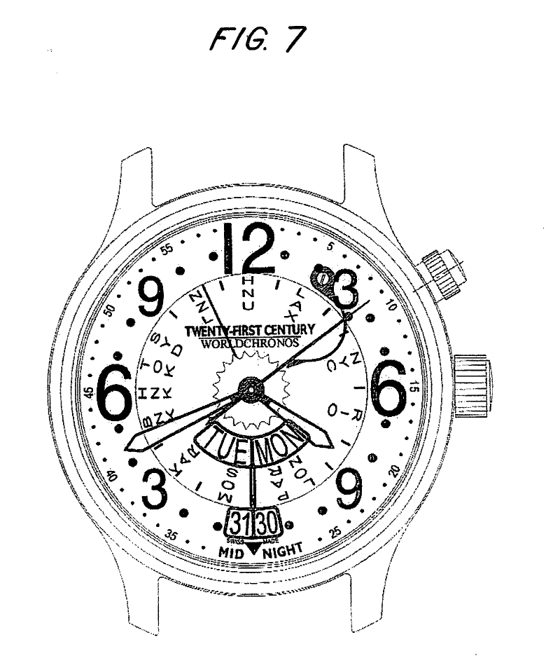

FIG. 7 a preferred embodiment of the timepiece as a men's or lady's wristwatch for the contemporary indication of local world times, week days and dates worldwide.

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting.

Before discussing the various non-limiting embodiments of this invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise in the following discussion, like numbers refer to like elements.

Shown in FIG. 1 is a universal global timepiece 10 incorporating features of the invention. Although this timepiece 10 is a wristwatch, it can likewise be made as a pocket watch, a table watch, a wall clock, a floor clock, or a locket watch pinned on clothing or hung on a chain or other mode of timepiece presentation. The timepiece 10 shown includes a case 12, a bezel 13, a face or dial face 14, an hour hand 16, a minute hand 18, a second hand 20, a transparent disk 22, and a wristband 24. This timepiece contemplates a double week day indicator, a double date indicator, and a rotating International Date Line indicator converging with a stationary New Day Line indicator, which features are discussed in detail below.

The case 12 preferably defines a generally circular shape, however it can have any shape, e.g. a polygonal shape having three or more sides, or an elliptical shape etc. The case 12 can be made of any material, e.g. of wood, metal or plastic and is preferably made from a corrosion-resistant metal or plastic. One or more setting buttons or knob orifices (hereinafter also referred to as “KO”) (shown in FIG. 1) or other types of mechanisms to activate elements of the timepiece are mounted on the case 12 with the shaft (not shown) of the setting buttons KO extending into the case 12 and connected to moveable components (not shown) of the watch, e.g. the hour hand 16, the minute hand 18, the second hand 20, and the transparent disk 22, to set the components to a desired position in a manner known in the art. The bezel 13 shown in FIG. 1, or bezel 13A shown in FIG. 2, can be positioned adjacent to the case 12 or inside the case and rotatable with respect to hour/minute indices 26B on face 14. The bezel 13 and 13A preferably defines etched minute/hour indicia 26, 26A, respectively, provided on a first bezel surface 28, with the minute/hour indicia 26, 26A (see FIGS. 1 and 2) preferably arranged in a 60 minute/24 hour arrangement, wherein the hours can be 24 consecutive hours. The hours of the minute/hour indicia 26, 26A can be colored coded to assist with differentiating between reading the minute versus the hour scale and can also be coated with a luminescent material to allow the minute/hour indicia 26, 26A to be seen in dimly lit areas. Alternatively, the bezel 13, 13A itself can also be illuminated.

With continuing reference to FIG. 1 and with further reference to FIG. 3, the face 14, 14A of the global timepiece 10 is preferably circumscribed by the case 12. FIG. 1 shows a first embodiment of the face 14. FIG. 3 shows another embodiment of the face 14A. As shown in FIGS. 1 and 3, the face 14, 14A can also define minute/hour indicia 26B. The minute/hour indicia 26B shown in FIGS. 1 and 3 can be interchanged with the minute/hour indicia 26, 26A shown on the bezel 13, 13A (FIGS. 1 and 2) or can be combined to form any other 1 to 24 hour arrangement. The indices 26B on face 14 can be divided into one set of one through twelve segments for the morning hours, and a second set of one through twelve segments for the evening hours. Color-coding to show morning and evening hours can also be interchanged, as appropriate. In another embodiment of the invention, all indicia described above can be illuminated or coated with luminescent material.

As shown clearly in FIG. 3 and with reference to FIG. 1 as needed, a first surface 30B of the face 14, 14A defines a pair of day windows 32 positioned on opposite sides of stationary New Day Line indicia 34. The New Day Line indicia 34 is on the first surface 30B of the face 14, 14A and extends from center C of the face 14, 14A to the twelve A.M. (midnight) hour point P on the face 14, 14A. The face 14, 14A can also define a pair of date windows 36 positioned on opposite sides of the New Day Line indicia 34. Although the day windows 32 are shown adjacent the center of the face 14, 14A, and the date windows 36 are shown adjacent the periphery of the face 14, 14A, the day windows and date windows can be positioned at any position from the periphery to the center of the face 14, 14A.

A thirty-one day rotatable wheel 35 (partially shown in phantom, shown only in FIG. 3) can be positioned beneath each one of the pair of date windows 36, between the face 14, 14A and the case 12, with the rotatable wheel 37 preferably rotating 360 degrees every thirty-one days. A seven week day wheel 35 (partially shown in phantom, shown only in FIG. 3) can be positioned beneath the pair of day windows 32, also preferably between the face 14, 14A and the case 12, with the seven week day wheel 35 rotating 360 degrees every seven days. The date wheel 37 and the week day wheel 35 are preferably synchronized with the minute hand 18 and the disk 22, and both date and week day wheels rotate counterclockwise. Because there are two date windows 36, day number thirty-one can be written with the “3” detached from the “1”, e.g. as “3/1” or “3·1” or similarly so that months having thirty days will prompt the wearer or viewer to read the date window 36 to the left of the New Day Line indicator 34 (left window designated as “L”) as “1”. When the date designated as “ 3/1” or “3·1” moves to the opposite right date window 36 (window to the right of new date line indicator designated as “R”), the date wheel 37 can be rotated by the wearer or viewer so that a “1” appears in right R date window 36 and a “2” appears in the left L date window 36 in the same manner as present design date wheels are cycled on months with less than thirty-one days.

With continuing reference to FIG. 3 but with equal applicability to FIGS. 1 and 2, the hour hand 16 is connected to a first rotatable shaft 38 positioned at the center C of the face 14, 14A and extending orthogonally away from the face 14, 14A. The minute hand 18 is connected to a second rotatable shaft 38A, with the minute hand 18 spaced away from both the face 14, 14A and the hour hand 16. Similarly, the second hand 20 is connected to a third rotatable shaft 38B and is spaced away from the face 14, 14A, the hour hand 16, and the minute hand 18. The transparent disk 22 is connected to a fourth rotatable shaft 38C and is spaced from the face 14, 14A. The hour hand 16, the minute hand 18, and the second hand 20 can be arranged between the face 14, 14A and the transparent disk 22 or above the face 14 and the disc 22. The hour hand 16 can be attached with the transparent disk 22 to the same shaft 38C and can be moved independently, or the hour hand 16 can be attached to a second hour shaft or otherwise constructed in any manner by those skilled in the art.

As can be appreciated by those skilled in the art, the driving arrangement 39 (FIG. 4) includes a gear arrangement and a powering unit, and any of the types known in the art can be arranged to practice the timepiece disclosed herein. For example, the gear arrangement can be powered by manually, e.g. by tightening a spring, or with wrist movement or electrically e.g., by a battery, by solar energy or house current.

In a preferred embodiment, the disk 22 and the minute hand 18 occur simultaneously to set world time and are movable by one of the setting buttons KO or other activation device. The hour hand 16 is preferably actuated by an independent setting button, e.g. the other one of the setting buttons KO, to set local time. Local time can be set according to the city or time zone where the wearer is currently standing by moving the hour hand 16 to that particular city or time zone. Once set, the hour hand 16 rotates coincident with the transparent disk 22 and the local time of the city. Changing the local hour hand from one local time to another when the wearer changes time zone locations does not change the position of the disk 22, which indicates the world time because world time does not change as people move across it. Accordingly, once set, the watch time, day or date need never be re-set due to the travel of the wearer. The traveling wearer need only rotate the hour hand to the new time zone and he or she is finished.

In another and preferred embodiment, the order is the face 14, 14A, the disk 22, the hour hand 16 (with a cut-out viewing window as shown in FIG. 4 so that the disk indicia can be seen), the minute hand 18, and the second hand 20. With the disk 22 adjacent to the face 14, 14A, the disk 22 is transparent. The first, second, third, and fourth rotatable shafts 38-38C are preferably nested hollow shafts, or other standard movement arrangement according to the state of the art.

The hour hand 16 rotates 360 degrees once every 24 hours; the minute hand 18 rotates 360 degrees every sixty minutes, and the second hand 20 rotates 360 degrees every sixty seconds. The hour hand 16 will normally be set at the time zone local to the wearer or observer so that local geographical time can be determined at a glance. Rotation of the rotatable shafts 38-38C, the date wheel 37 (see FIG. 3), and the week day wheel 35 (see FIG. 3) can be accomplished through the driving arrangement 39 (see FIG. 4), a manual or electronically-driven or otherwise powered timepiece movement mechanism is readily understandable to one skilled in the art.

With continuing reference to FIGS. 1 and 3, and with further reference to FIG. 4, the transparent disk 22 defines a generally circular shape and is subdivided into 24 hour time zones. As partially shown in FIG. 4, the times zones are indicated by geographical indicia 40, which are preferably etched onto a first disk surface 42 of the transparent disk 22 and preferably painted with a highly luminous and visible paint. The transparent disk 22 is spaced away from the face 14, 14A, and the hour hand 16, the minute hand 18, and the second hand 20 can be arranged in between or above the transparent disk 22. In the latter case, the transparent disk 22 is arranged closely or almost adjacent to the face 14. International Date Line indicia 44 extends from a center CE of the transparent disk 22 to an outermost edge E of the transparent disk 22 at a point PO opposite to and aligned with the indicia 40A, which indicates Greenwich Mean Time (GMT), such as London, England, or Keflavik, Iceland.

As noted above, the hour hand 16, minute hand 18, second hand 20, and transparent disk 22 all rotate above the first surface 30B of the face 14, 14A. The time zones on the disk 22 are spaced from one another to correspond to the distance between the hours on the dial face. By referring to the geographical indicia 40 positioned on transparent disk 22, a wearer or observer can also instantly determine the local time of any other time zone in the world. For example, if Tokyo (“TOK”) indicia positioned on the transparent disk 22 is coincident or points to the 0200 or 2:00 AM indicia positioned on the face 14, 14A, it is 0200 local time in Tokyo. GMT or Zulu time can also be determined by viewing the local time for London (“LON”), Keflavik, or other suitable geographically located city. Further, the wearer or observer can also determine in a general manner whether it is day- or night time at any time zone. For this purpose, the face 14 may be fragmented into two crescent parts of different color, one covering the lower crescent half of the face 14 and one the upper crescent half of the face 14. The lower half then representing a twelve-hour more or less night time period and the upper representing a twelve-hour more or less daytime period in respect to the time zones indicated on the overlying transparent moving disc. Further, the wearer or observer can also determine the present week day and date for all time zones by referring to the New Day Line indicia 34 (see FIG. 1) positioned on the first surface 30B of the face 14, 14A and the International Date Line 44 positioned on the transparent disk 22 (see FIG. 4). Those geographical locations positioned on the transparent disk 22, which are located between the New Day Line indicia 34 clockwise to the International Date Line 44, will be in the week day/date indicated in the week day/date windows 32,36 on the left side L of the New Day Line indicia 34, while those time zones between the New Day Line indicia 34 counterclockwise to the International Date Line 44 will be in the week day/date windows 32, 36 indicated on a right side R of the New Day Line indicia 34.

With continuing reference to FIG. 4, most Northern Hemisphere countries observe Daylight Savings Time (DST), so calibrating the watch to Northern Hemisphere Daylight Savings Time observing countries and setting the local time in the United States of America will automatically compensate for DST in most Northern Hemisphere countries. The few Northern Hemisphere countries that do not observe DST, such as Beijing, China, and Tokyo, Japan will have their local time pushed back during Northern Hemisphere DST one time zone relative to the others. To help correct for DST for non-complying time zone cities, these time zone cities located on the transparent disk 22 have a short line SL extending from the city in a counterclockwise CCW direction, and have a “D” indicia positioned at the end of the short line SL. The “D” indicates that during DST, that particular time zone (relative to most of the Northern Hemisphere observing DST) is represented by the time zone in the hour before the actual location of the time zone.

For watches calibrated to Northern Hemisphere Daylight Savings Time observing countries, countries located south of the equator present a more complicated DST problem. Most countries geographically located south of the equator do not observe DST, and those that do are on DST when Northern Hemisphere countries are observing standard time (“ST”). Two major southern hemisphere cities that observe southern DST are Sydney, Australia and Rio de Janeiro, Brazil. Accordingly, with this version of the watch reading the time from the perspective of the Northern Hemisphere, these locations will have the same “D” line device running to the adjacent time zone in the counterclockwise direction CCW, similar to the Tokyo and Beijing examples discussed above. However, Southern Hemisphere countries observing Daylight Savings Time opposite to the Northern Hemisphere, including Sydney and Rio de Janeiro will also have an “S” line indicia running in clockwise-direction CW, one time zone to the right. The “S” line indicia indicates that during standard time in the Northern Hemisphere, Sydney and Rio de Janeiro will be on their own DST and, thus, will be one hour ahead of their regular time difference with respect to the Northern Hemisphere.

In another non-limiting embodiment of the invention, bodies 45 and/or ends 46 of the hour hand 16, the minute hand 18, and the second hand 20 can have different configuration to quickly distinguish between the hour, minute, and second hands. For example, the body 45 of the minute hand 18 is thicker than the body 45 of the second hand 20, whereas the body 45 of the hour hand 16 has a hole in the body 45. Further, the second hand 20 has an arrowed end 46, the minute hand 18 has a pointed end 46, and the hour hand 16 has an arrowhead larger than the arrowhead of the second hand 20. As can now be appreciated, hands 16, 18, 20 can have any type of end design.

FIG. 5 is an illustration of a virtual prototype of a presently preferred embodiment of the timepiece. This prototype global timepiece in FIG. 7 includes a wristwatch having the case 12, the bezel 13, the face 14, the hour hand 16, the minute hand 18, and the second hand 20. The transparent disk 22 is also included on the virtual prototype, along with the wristband 24. The bezel 13 includes etched minute/hour indicia 26 and the stationary New Day Line indicia 34 located on the face 14 extending from the center C of the face 14 to the point P on the face 14. The windows 36 are located on either side of the stationary New Day Line 34. In most other material respects, the virtual prototype wristwatch shown in FIG. 5 is constructed and operates in the same manner as described in connection with the embodiments shown in the Figures and discussed above.

Additional information, or other data, can also be included on any of the faces 14, 14A. For example, FIG. 6 shows a 24 hour alarm dial 70 positioned on any of the faces 14, 14A, with the dial 70 actuated by knob 72 in any usual manner. More particularly, the alarm dock has a one to 24 hour alarm dial and function on the main dial face that is set independently of the time indicated or shown on the face of the watch. The alarm time is set forward from the time of setting up to 24 hours in advance, and is useful to calculate the time desired for an alarm not against the local time but against the number of hours forward for events that may be occurring anywhere in the world. Further, the dial face as shown in FIG. 6 has room to provide other features, for example, a chronograph (stop watch), a power reserve indicator, a moon phase indicator, an alarm indicator, etc.

FIG. 7 shows a preferred embodiment of the timepiece as a wristwatch for men or ladies. This wristwatch offers the contemporary indication of local world times, week days and dates worldwide. The hour hand revolves 360 degrees every 24 hours. This means that this watch must be read in a different way than usual. The watch is divided into the right half section which covers the 12 hours time period from noon to midnight and the left half section the 12 hours time period from midnight to noon. The minute hand moves around 360 degrees in one hour and therefore revolves conventionally. The outer number ring on the dial face shows the minutes from 0 up to 60 minutes. An adjacent inner number ring with larger numbers indicates the hours in the two half sections, that is the AM hours on the left side and the PM hours on the right side of the watch. The transparent disk lays over the dial face and revolves 360 degrees in 24 hours. Therefore, the transparent disk which does indicate the main time zones by way of abbreviations of major cities in those time zones moves exactly uniformly with the hour hand. It is though possible to create a similar watch having an hour hand which does move conventionally, that is 360 degrees in a 12 hour period. All the remaining parts of the watch remain the same, with the exception that the hour hand must be read conventionally. In order to ensure this at all times, this watch then can include on outer ring on the dial face which pertains to the hour hand and indicates the 12 hours around 360 degrees whereas an inner ring on the same dial face indicates two time periods of 12 hours each around 360 degrees, that is from noon at the top center down to midnight at the bottom center and again noon at the top.

In conclusion, the present invention provides a universal global timepiece which displays the world time in a new and unique manner including for the first time showing the world's dual week days and dual dates existing simultaneously across the globe. This timepiece also shows which time zones are in which week day and which date and how these change from hour-to-hour and day-to-day and does so while still allowing more room on the dial than present world time watches to allow for showing additional traditional related information. Minute/hour indicia are generally arranged in a 60 minute/24 hour format and can be positioned on the bezel, the face, or both. The bezel is rotatable, so that when a reference point on the bezel is aligned with the minute hand, elapsed minutes can be calculated as the minute hand continues to rotate after the bezel is set and, when aligned with the hour hand, elapsed hours can be calculated as the hour hand continues to rotate after the bezel is set.

1-10. (canceled)

11. A global timepiece, comprising:
a case;
a movement mechanism having a drive mechanism housed in said case;
a face positioned over said movement mechanism, with said drive mechanism extending through said face (14), having at least an hour hand and a minute hand; and,
a transparent disk overlying said face, said face including a New Day Line extending radially from a central point of said face outwardly to an indice indicating midnight, said transparent disk being operationally connected to said drive mechanism by which said transparent disk and said hour hand are rotating 360° in a clockwise direction within 24 hours, said transparent disk further including an International Date Line indicia, time zone indicia represented by areas geographically located within each corresponding said time zone for indicating local times around the world contemporarily.

12. The global timepiece according to claim 11, wherein said drive mechanism includes at least one rotatable shaft.

13. The global timepiece according to claim 11, further comprising:
two windows for indicating two successive dates, said two windows being aligned astride said New Day Line; and,
a wheel beneath said two windows moving counterclockwise and indicating on a circumferential top area of said wheel a plurality of dates, thereby allowing said time-piece to show two successive dates in said two windows continuously existing contemporarily around the world and world locations in which date, and when the date, for each world location changes.

14. The global timepiece according to claim 11, further comprising:
two windows for indicating two successive days of a week, said two windows being aligned astride a New Day Line; and,
a wheel lying beneath said two windows moving counterclockwise and indicating on a circumferential top area of said wheel days of the week for permitting said wheel to show two successive days of the week in said two windows continuously existing contemporarily around the world and world locations in which the day of the week for world locations changes.

15. The global timepiece according to claim 11, wherein said face is fragmented into an upper crescent half of a first color and a lower crescent half of a second color, said first color and said second color being different colors, said lower crescent half representing a twelve-hour night time period and said upper crescent half representing a twelve-hour daytime period of the time zones indicated on the overlying said transparent disk and, further including, Daylight Saving Time conversion indicia, so that local times around the world are indicated contemporarily taking into account locally observed Daylight Saving times (DST).

16. The global timepiece according to claim 11, wherein said face comprises:
a major surface;
an indicia defined as a New Day Line on said major surface of said face and extending from a central region of said face to a lower edge of said face;
a first window left of the New Day Line;
a second window on right of the New Day Line and aligned with said first window;
a third window on a same side of the New Day Line and spaced from said first window;
a fourth window on a same side of the New Day Line as said second window and aligned with said third window;
a first wheel having seven days of the week and moving counterclockwise; and,
second wheel having a range of numbers of 1 to 31 and also moving counter-clockwise, wherein said movement mechanism rotates said first wheel and said second wheel for displaying both, simultaneously, two successive existing days of the week on said first wheel in said first window and said second window, respectively, and to individually display both, simultaneously, two successive dates of the month on said second wheel in said third window and said fourth window, respectively.

17. The global timepiece according to claim 11, further comprising markings for indicating at least a 24-hour day and 60 minutes and equally divided into two 12-hour periods may be selected whereby said markings are arranged on said case or on a marginal edge area surrounding said face, the difference between the two 12-hour periods is selected from a group of color, design of number and combinations thereof.

18. The global timepiece according to claim 11, further comprising markings for indicating at least a 24-hour day and 60 minutes and equally divided into two 12-hour periods whereby said markings are arranged on a bezel rotatably mounted on said case, the difference between the two 12-hour periods is selected from a group of color, design of number and combinations thereof.

19. The global timepiece according to claim 11, further comprising markings for indicating hours and minutes on said face, said markings comprising numbers “12,” “3,” “6” and “9” with hours “1,” “2,” “4,” “5,” “7,” “8,” “10” and “11” being indicated only with points or lines, and that these markings are indicated on said case or on a bezel.

20. The global timepiece according to claim 11, further comprising a second hand spaced from said hour hand, said minute hand and a free end of each said second hand, said minute hand and said hour hand having a different end configuration.

21. The global timepiece according to claim 11, further comprising a 24-hour alarm dial.

22. The global timepiece according to claim 11, wherein said hour hand revolves around 360° in a 12-hour period and an outer marginal ring on said face, pertaining to said hour hand and indicating 12 hours around 360°, wherein an inner ring on said face indicates two time periods of 12 hours each around 360° on a margin of said face.
